(19) United States
(12) Patent Application Publication
(10) Pub. No.: US 2004/0208538 A1
(43) Pub. Date: Oct. 21, 2004

(54) Optical network architecture for WDM communication

(76) Inventor: Michael Liwak, Pickering (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/078,342

(22) Filed: Feb. 21, 2002

(51) Int. Cl. H04J 14/02

(52) U.S. Cl. 398/45

(57) ABSTRACT

A network architecture for supporting switched burst optical data traffic is disclosed. According to the architecture a plurality of optically coupled nodes is provided. At each optical output port of each node, a wavelength division multiplexed optical signal is provided having a predetermined relative intensity profile such that each optical input port coupled within the network and for receiving a wavelength division multiplexed signal from an output port is for receiving a wavelength division multiplexed signal with an approximately same relative intensity profile. In such an architecture a node supports switching of the wavelength division multiplexed signals and some of the optically coupled nodes are absent circuitry for performing dynamic gain equalization. The predetermined relative intensity profile indicates relative intensities between wavelength channels for which an optical data signal is present.

### FIELD OF THE INVENTION

The invention relates to optical networks and more particularly an optical network having predetermined multiplexed signal intensity profiles.

### BACKGROUND OF THE INVENTION

Optical networks are commonly used to move large amounts of data over long distances. Typically, the data is stored electrically, converted to an optical signal at a first node and provided to a second node. Upon arriving at the second node the data is converted back to an electrical signal. In most applications, it is advantageous to make the optical network as flexible as possible. Thus, ideally, network resources are allocated to moving data between nodes with the highest demand for bandwidth. Those nodes with less demand have fewer resources allocated to them. When demand shifts, the allocation changes and thus the network is used efficiently. Since modern optical networks use dense wavelength division multiplexing or DWDM it is common that individual channels of the DWDM signal within a single fibre have different origins in response to resource allocation changes. Optical signals have intensities that vary as they propagate along an optical path within an optical network as a result of the attenuation properties of optical components disposed along the optical path as well as the attenuation properties of the fibre. This has the unfortunate consequence of varying the intensity of the individual optical signals within the fibre. The variation in optical intensities represents a complicated problem in a DWDM optical signal because each optical signal corresponding to a specific wavelength channel has an intensity, thus a DWDM optical signal has an intensity profile. When a conventional amplifier amplifies such a signal, the amplifier provides gain to each optical signal. A variation in intensity levels within an intensity profile is known to have a negative impact on the performance of the optical receivers that receive the amplified optical signals. Ideally the wavelength profile is flat and the optical signals that are present have an equal predetermined intensity and optical signals that have been dropped have an intensity that is negligible. The predetermined intensity is chosen to avoid any saturation problems with the amplifier. When the intensity of an optical signal provided to an optical amplifier is too great the amplifier will saturate. A person of skill in the art of optical networking will be aware that saturated optical amplifiers provide optical signals with more noise and therefore saturation of optical amplifiers should be avoided when the signal to noise ratio is of concern. In an optical network with saturated amplifiers, optical signals are repeatedly optically amplified, and this problem is worsened. If this problem is not properly addressed in a conventional optical network with many amplifiers then the signal to noise ratio will often be inadequate. When the signal to noise ratio is too low it becomes difficult to separate the signal from the noise and the resulting bit error rate will be unacceptable. Since the optical signals are digital one way of dealing with this problem is to return the optical signal to the electrical domain, eliminate the noise on the signal and return the optical signal to the optical domain. This is commonly referred to as an OEO conversion and it is avoided where possible mainly because it is very costly.

In a conventional optical network, monitoring optical signals within an optical fibre and equalizing them with a dynamic gain equalizer (DGE) deals with this problem. Equalizing the optical signals this way causes all of the optical signals to have an optical intensity that is roughly equivalent to the weakest optical signal. Unfortunately, a conventional dynamic gain equalizer reacts to the intensity of an optical signal when it perceives the intensity of the optical signal. In a typical DGE this action is performed rapidly, however it is still too slow to eliminate the problem and therefore, the DGE is only able to mitigate the problem of unequal optical signal intensities. Recent advances in DGE technology have produced faster DGEs however these items are have only limited commercial availability arid are expected to add significant complexity to an optical network.

In a Sonet network, optical signals are time division multiplexed and optionally also wavelength division multiplexed. This allows optical nodes within a ring to use optical signals at specific wavelengths, during specified intervals to communicate. In many applications this is adequate however it does not represent an efficient use of network resources. For example, in a Sonet network supporting ten nodes, if a first node sends data to a second node at a first wavelength then other nodes are prohibited from using that wavelength until the first node releases it. This type of architecture is a rational option for supporting voice traffic but less effective for supporting data traffic. A person of skill in the art would describe data traffic as being “bursty” in comparison to voice traffic. For example, typically, no data traffic would exist between a source and receiver however, an instant later a demand for transferring data is requested. The data is rapidly transferred and then connection between the source and receiver is not needed until another request for data is made. In comparison to data traffic, typical voice traffic—a telephone conversation—takes place for a relatively long period of time and involves a relatively small amount of digital information being transferred. In this case, the data is transferred continuously between the sources and receivers.

In an optical burst network, optical paths are created and removed between a source and a destination very rapidly. In this type of network an optical path is created between the optical source and the optical receiver and therefore intermediate optical switches do not need information contained in the data burst to choose the correct path. In an article titled “Just-In-Time Signaling for WDM Optical Burst Switching Networks”, in the Journal of Lightwave Technology, Vol. 18, No. 12, December 2000, Wei et al. discuss the advantage of combining high frequency laser sources with an optical burst switching network. Wei describes optical burst networks and algorithms for controlling them. Wei does explain a key advantage of an optical burst network. Specifically, in an optical burst network with fast switching it is not necessary to provide large buffers proximate the optical sources. The control and protocol system for optical burst networks that Wei describes is highly advantageous over conventional optical networks. Unfortunately, Wei does not go into detail with regards to the specifics of the optical topology and specific components required by an optical burst network.

Recent advances in optical component technology have produced commercially available lasers that transmit up to 400 bits per second per wavelength channel. A few years ago 2.5 Gbits per second was the standard. Unfortunately, optical networks are not always able to take full advantage of this type of improvement. For example, when the amount of information being transferred using a specific wavelength channel is relatively small, a very fast laser provides only a modest advantage over a slower laser because of the time that components like a conventional DGE use to equalize optical signals. High speed lasers are still very beneficial for conventional optical networks that share vast amounts of data using optical connections that are infrequently switched. For example, a point to point network features optical paths that are effectively fixed. The time necessary to reconfigure this type of network is given in minutes. This duration inhibits resource sharing in the network however it does allow network resources to be reconfigure in the event of a catastrophic failure of a component within the network when such a failure requires that optical signals bypass the damaged component.

Recent advances in optical switching technology have produced optical switches with very fast switching. For the purposes of this document a fast switch has a switching speed less than 20 μsec. Faster switches offer optical network designers the opportunity to consider optical burst networks as realistic alternatives to conventional optical networks. Unfortunately, there are other optical component problems that hinder the deployment of optical burst networks. For example, the time required to equalize optical signals remains a problem if conventional dynamic gain equalizers are used. A person of skill in the art of optical burst networking will realize that an optical burst network that features such components will be subject to high bit error rates (BER) due to transients and optical intensity fluctuations within such a network. Recent advances in dynamic gain equalizer technology suggest that faster DGEs will be available however they are costly and add significant complexity to the network. The transients are produced when optical signals are switched resulting in a change in the optical intensity profile of the optical signal. In an optical burst network, switching is likely to occur very frequently and consequently transients represent a significant problem for this type of network because transients tend to increased bit error rate. As previously described amplifiers that receive the transient optical signal complicate this type of problem.

In U.S. Pat. No. 6,304,347, Beine et al. describe an optical network in which the nodes transfer data associated with supported wavelength channels and their intensity. When it is desired to send data from a first node to a second node, the first node verifies that a wavelength channel having a supported wavelength is available prior to sending the data. Thus, the optical signal has a known intensity that is appropriate and, therefore, the bit error rate is kept at an acceptable level. When the intensity data indicates that a conflict will result the optical data signal is delayed until an appropriate route is available. The Beine patent discloses technology that is well suited to conventional optical networks that do not experience frequent switching. Beine describes a method of computing parameters of different switching events, such as restoration, which are classified as different modes. Adjustments to variable optical attenuators are made as expected optical loss characteristics of optical paths between nodes vary due to different switching events. Thus, the computed values are used to vary the attenuation of the variable optical attenuators.

Beine et al. use variable attenuators to change the optical loss of links between nodes. The embodiments provided do not include an optical burst network and the embodiments described cannot easily and flexibly support an optical burst network. Although this prior art power management system may be useable with optical burst networking it is better suited to power management in conventional optical networks according to the embodiments disclosed by Beine. In a complex optical burst network with a large number of nodes that experiences very frequent switching; it would be preferable to avoid adjusting the variable optical attenuators for each switching event.

It would be beneficial to provide an optical power management system for optical networks that is fast, reliable, inexpensive and easily produced from existing optical networking components. Additionally, it would be advantageous to provide a power management system for optical networks and that responds sufficiently quickly to support optical burst networking. Further, it would be beneficial to provide an optical power management system that is able to monitor the critical components of an optical network and warn technical support staff of failing equipment prior to any interruption of the network.

### SUMMARY OF THE INVENTION

The invention discloses a network architecture for supporting switched burst optical data traffic comprising: a plurality of optically coupled nodes, wherein, in use, at each optical output port of each node, a wavelength division multiplexed optical signal is provided having a predetermined relative intensity profile such that each optical input port coupled within the network and for receiving a wavelength division multiplexed signal from an output port is for receiving a wavelength division multiplexed signal with an approximately same relative intensity profile, wherein at least a node supports switching of the wavelength division multiplexed signals and wherein at least some of the optically coupled nodes are absent circuitry for performing dynamic gain equalization, the predetermined relative intensity profile providing relative intensities between wavelength channels for which an optical data signal is present.

In another aspect of the invention there is disclosed network node for supporting burst optical data traffic comprising: a first node having a plurality of input ports and an output port, the first node for being provided a plurality of input wavelength division multiplexed signals each including channel signals within different wavelength channels having a same predetermined intensity profile, for switching of the channel signals and for providing a first output signal having channel signals from different optical signals of the plurality of input wavelength division multiplexed signals and having a first predetermined output intensity profile, the first node absent a gain equalizer for actively equalizing wavelength division multiplexed signals provided at the output port thereof or at the input ports thereof.

The invention also teaches an optical component comprising: a first input port for receiving a plurality of optical signals multiplexed within a same waveguide; a second input port for receiving data, the data indicative of signal intensities of signals within a multiplexed signal, the signal intensities detected at each of a plurality of input ports of another optical component; and, an optical amplifier/attenuator for amplifying optical signals within the multiplexed optical signal independently, the amplification performed in dependence upon a signal received at the second input port, the amplification for equalizing signal intensities at the input port of the another optical component, and the amplification performed in an approximately fixed fashion wherein the amplification other than varies dynamically with signal intensity of the received data signals, wherein the optical component is absent gain equalization means prior to the signal being provided to the optical amplifier.

Further the invention describes a method of equalizing a multiplexed optical signal comprising the steps of: providing a first optical component and a second other optical component separated by a distance and disposed at different network locations;

providing a wavelength multiplexed optical signal to a first input port of the first optical component; monitoring the provided optical signal to determine an intensity profile thereof proximate the first input port;

providing a feedback signal indicative of the monitored intensity profile to the second other optical component; receiving the feedback signal at the second other optical component; within the second other optical component, setting a fixed amplification for different optical signals within said wavelength multiplexed optical signal, independently in dependence upon the received feedback signal; and, providing the amplified multiplexed optical signal from the second other optical component to the first optical component, the fixed amplification for resulting in an approximately fixed relative intensity profile for each amplified multiplexed optical signal.

The invention also discloses a method of equalizing a multiplexed optical signal comprising the steps of providing a first wavelength multiplexed optical signal to a first input port of a first optical component; providing a second wavelength multiplexed optical signal to a second input port of the first optical component;

monitoring the first optical signal to determine an intensity profile thereof proximate the first input port; monitoring the second optical signal to determine an intensity profile thereof proximate the second input port; providing a first feedback signal indicative of the monitored intensity profile to a second other optical component; providing a second feedback signal indicative of the monitored intensity profile to a third other optical component; receiving the first feedback signal at the second other optical component;

receiving the second feedback signal at the third other optical component; within the second other optical component, amplifying optical signals within said wavelength multiplexed optical signal independently in dependence upon the received first feedback signal; within the third other optical component, amplifying optical signals within said wavelength multiplexed, optical signal independently in dependence upon the received second feedback signal; providing the amplified multiplexed optical signal from the second other optical component to the first optical component; and

providing the amplified multiplexed optical signal from the third other optical component to the first optical component, wherein the intensity profiles of the received multiplexed optical signals at the first optical component are within known tolerances of at least a predetermined intensity profile.

Further, the invention provides a method of transmitting optical data comprising: providing a test signal with a known intensity from a transmitter, monitoring the intensity of the test signal proximate an amplifier/attenuator, providing data from the monitor to the amplifier/attenuator, setting the amplifier/attenuator to a predetermined gain response in dependence upon the data provided from the monitor, providing a wavelength multiplexed data signal from the transmitter, amplifying the wavelength multiplexed data signal according to the gain response of the amplifier/attenuator and absent dynamic gain equalization.

### BRIEF DESCRIPTION OF THE DRAWINGS

FIG. 1 is a diagram of a prior art optical network using a ring architecture;

FIG. 2 is a diagram of an optical network according to the invention with a single switch fabric;

FIG. 3 is a diagram of an optical network featuring multiple switching fabrics according to the invention;

FIG. 4 is a diagram of an ring architecture optical network according to the invention;

FIG. 5 is a diagram of an optical network according to the invention featuring a complex switch fabric and a simple switch fabric;

FIG. 6 is a diagram of an embodiment of the invention featuring a network monitoring device; and,

FIG. 7 is a diagram of an embodiment of the invention featuring an established network that is being upgraded with an additional switching fabric; and,

FIG. 8 is a diagram of an embodiment of the invention for supporting optical paths with wavelength dependency.

### DETAILED DESCRIPTION

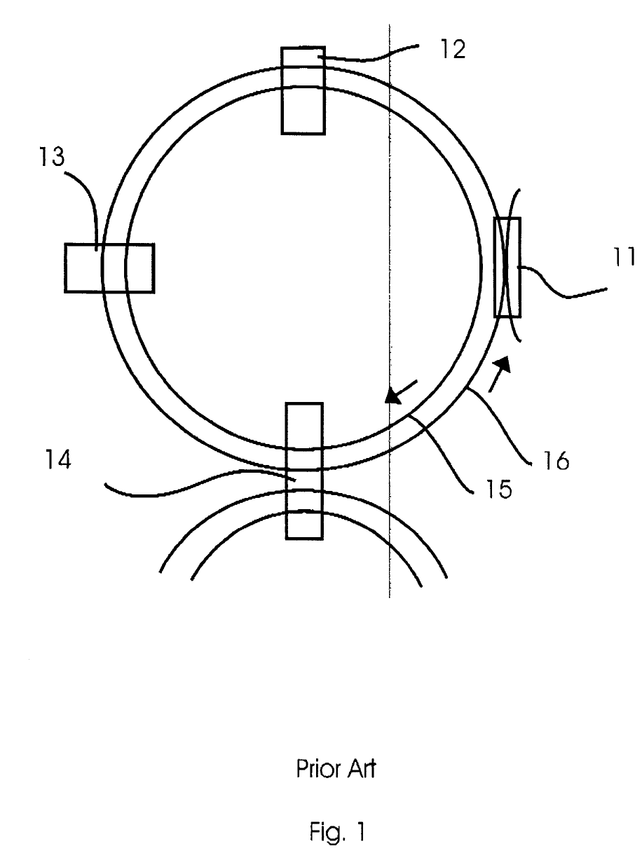

Referring to FIG. 1, a prior art optical network is shown. The network has four nodes 11, 12, 13 and 14. These nodes are connected by a pair of optical fibre rings 15 and 16. In the first fibre ring 15 signals are sent in a clockwise direction and in the second fibre ring 16 signals are sent in the opposite direction. The node 11 is an add/drop unit that allows the optical network to receive optical signals from other optical networks. In this network the optical signals are transmitted from the nodes and therefore, it is easy to ensure that the optical signals all have a predetermined intensity when they are transmitted. However, when an optical signal reaches a node, the node either receives the optical signal or causes it to bypass the node. If a node receives the signal but the receiving node is not the correct destination then the node regenerates the signal. This is referred to as an OEO conversion. The equipment associated with this type of conversion is very expensive. Alternatively, the signal is routed through the node with no OEO conversion. Assuming that the signal propagates through the node without being converted, the intensity of the optical signal will vary at different points in the network because the distance between the transmitting node and the destination node vary. Additionally, the signal will loose intensity as it propagates through passive optical components. When the optical signal propagates through the node without being converted to an electrical signal the signal is being manipulated by passive components that introduce some attenuation into the signal.

For example, if node 12 provides an optical signal to node 13 along the outer ring 16 then the signal arrives at node 13 having traversed at minimum of distance and not having crossed any intervening optical components. The same signal propagating between the same nodes but in the opposite direction propagates further and traverses nodes 11 and 14. Consequently, an optical signal propagating along the second described path would have less optical intensity when it is detected at the destination node than it would if it were transmitted along the first described path. Thus, in a conventional optical network it is common that optical signals have differing intensities in dependence upon the optical path chosen between the source and the receiver. Typically, solving this problem requires additional equipment that continuously adjusts the intensity of the optical signals.

The intensity of an optical signal provided to the network from the add/drop unit 11 is likely to be different from the intensity of other optical signals within the network. In fact, the intensity of optical signals provided by the add/drop unit 11 is often unknown prior to monitoring them. While this network is shown with only four nodes it is clear that additional nodes will increase the complexity of the network. Ideally, the optical signals will have an intensity that lies within predetermined range when they are provided to the receivers. When the intensity of the optical signal is below this predetermined range it becomes difficult to separate the optical signal from noise provided with the signal. When the intensity is above this predetermined range a detector within all optical receiver will likely saturate. In either case the bit error rate increases. Also it is desired that optical signals have a signal to noise ratio (SNR) above a predetermined value when the optical signals are received. When the SNR is too low, the signal becomes difficult to read and the bit error rare (BER) increases. In many instances the intensity of an optical signal is not easily established until it has been received or monitored. In order to maintain the intensity of an optical signal within a desired range an optical amplifier is provided along all optical path where the optical signals are likely to require amplification.

An erbium doped fibre amplifier (EDFA) deployed within an optical network consistent with FIG. 1 will receive optical signals with a wide variety of intensity profiles. In the event that the optical signal received by the EDFA is too intense it will cause saturation of the EDFA. The response of the amplifier will adversely affected as previously described. When the EDFA is saturated it is unable to provide the intended amount of gain to the optical signals within each wavelength channel. In order to saturate an optical amplifier this way, some of the optical signals provided to the amplifier have an intensity that is much higher than intended. If such an optical signal does not receive the normal amount of amplification it will still likely have a relatively high intensity when it propagates from the optical amplifier. However, a relatively weak optical signal that is amplified by the same saturated optical amplifier will receive an insufficient amount of amplification and therefore remain relatively weak. This is particularly problematic in the event that the optical signal provided by the amplifier is sufficiently intense to saturate subsequent EDFAs along the optical path. Typically, in a conventional optical network—meaning one that is designed to operate with EDFAs in an unsaturated mode and having EDFAs disposed to offset attenuation within the network—this will result in the weak signal becoming weaker after each stage of amplification. In the event that the weak optical signal becomes sufficiently weak it will be difficult to receive, and therefore the bit error rate is adversely affected.

Referring again to U.S. Pat. No. 6,304,347, Beine et al. dismiss the notion of using fixed attenuators between optical nodes in order to ensure that the optical intensity is at a predetermined value. Beine describes the problems associated with fixed attenuators. Namely, that manual configuration is prone to errors, each node must be engineered—presumably meaning that each node is calibrated—per site, upgrading and maintaining nodes becomes more difficult and it is difficult to add nodes to an existing network. These concerns are quite valid Using fixed attenuators, or attenuators that require manual calibration represents additional work that is a cost of maintaining the network. Clearly it is advantageous to minimize costs of this nature.

In order to overcome the limitations of the prior art previously described, a new architecture for an optical network is proposed. The network architecture makes use of symmetry to ensure that the appropriate level of optical signal intensity is present at any given set of similar components in the network. In order to achieve this result, the optical gain characteristic for a given optical link is set when the link is established. Since all of the optical links are established this way, the optical signals have substantially equal intensities at predetermined locations within the network, regardless of their origin and the optical path along which they have propagated. Thus, a predetermined power level is achieved where it is necessary by design. Additionally, a network according the invention ensures that all of the optical sources that are optically coupled to a specific component, such as a switch fabric, produce optical signals that either have a substantially equal non-zero intensity or a near zero optical intensity. Unlike an optical network using fixed attenuators to achieve similar functionality, a network according to the invention features variable attenuation and signal monitoring to ensure that the anticipated optical intensity is present at various locations within the network. Unlike the prior art optical network of Beine, an optical network designed according to the invention is symmetric and the various optical paths have substantially equivalent optical characteristics and therefore the attenuators are not typically adjusted during ordinary use of the network, including switching events, such as adding and dropping optical signals corresponding to specific wavelength channels from an optical path or changing optical paths. However, the equipment to vary the attenuation characteristics is provided within the network and therefore the attenuation characteristic is easily varied as desired.

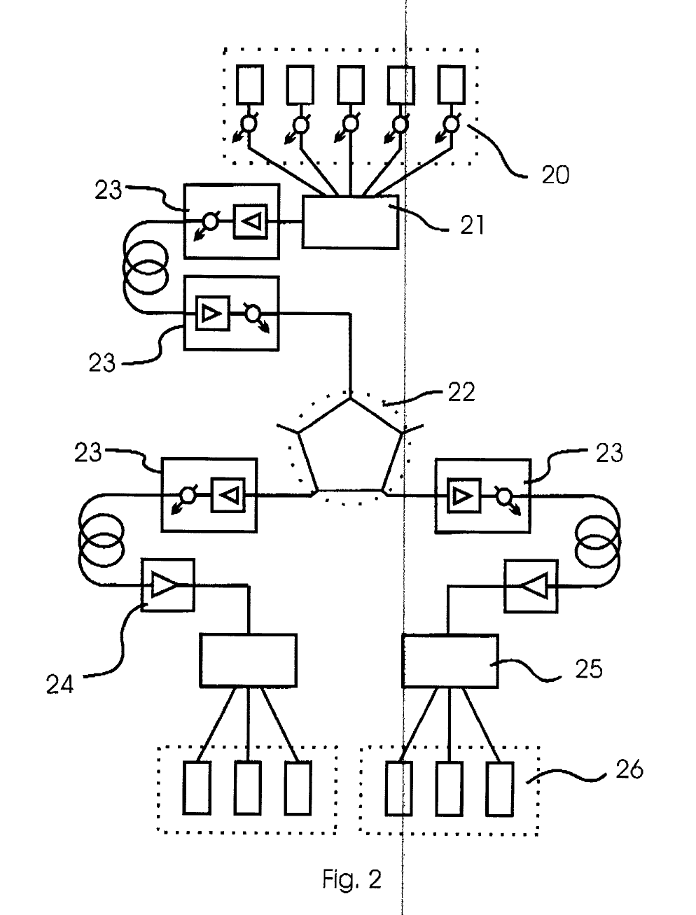

Referring to FIG. 2, a network according to a first embodiment of the invention is shown. A first set of laser sources 20 are provided. The laser sources 20 represent an assembly of a laser and variable attenuator. The laser provides a modulated signal that is optionally attenuated by the attenuator. The laser sources 20 are optically coupled to a wavelength multiplexer 21 that combines the optical signals and provides a wavelength multiplexed optical signal to an amplifier module 23. The amplifier module comprises an amplifier with monitoring capability and a variable attenuator. The amplifier module ensures that optical signals provided by the laser sources are at a predetermined optical intensity when these signals propagate to another amplifier module in this embodiment, the amplifiers within the amplifier modules are operated at a continuous gain level and the attenuators are used for varying the intensity of the optical signals provided by the amplifier modules 23. The optical signals then propagate through a length of optical fibre. The fibre has an attenuation characteristic that depends upon the type of fibre used and the length of the fibre. The optical signal is then provided to a second amplifier module 23 where the intensity of the optical signals is adjusted again prior to being provided to the switching fabric 22. The switching fabric 22 is designed to allow the optical signal arriving at a first port to propagate to any of the other ports, or to none of the other ports based upon input signals from an external switch controller (not shown). All of the optical ports of the switching fabric 22 are designed to receive optical signals having a same predetermined intensity. Thus other banks of optical sources, multiplexers, amplifier modules and lengths of optical fibre analogous to the set previously described are optionally coupled to other optical ports of the switching fabric. Additionally, the switching fabric 22 is designed such that every optical signal propagating through the switching fabric experiences a substantially equivalent amount of attenuation regardless of the optical path that it follows. The optical signal propagates from the switching fabric 22 to another amplifier module 23 and is then provided to a length of optical fibre. The optical signal is then provided to an amplifier 24. It should be noted that this amplifier duos not have the precise intensity control and feedback system of the amplifier modules 23. A person of skill in the art of optical network design will be aware that the control of the intensity of the optical signal is no longer as critical because the optical signal will not be amplified again. The amplifier 24 is provided to ensure that the optical signal has sufficient intensity that it is accurately received. The optical signals then propagate to a demultiplexer 25. The demultiplexer 25 will provide optical signals to the appropriate receivers 26 in dependence upon the wavelength of the optical sisal. Since every optical signal that is not attenuated goes through a path where all likely paths have substantially equal attenuation, the optical signals have equal intensity when they reach any specific stage of the network, regardless of their origin. Based upon the intensity of the optical signals at any given point it is a relatively simple matter for one of skill in the art of optical network design to determine where optical amplifiers will be needed to ensure the proper functioning of the network. Additionally, since the optical paths are known when the optical signals are provided, it is a simple matter to predict the intensity of any optical signal at any point within the path. The network shown in FIG. 2 is shown with component diagrams are indicative of directional behavior however, a person of skill in the art will be aware that adding additional commercially available components, such as isolators and circulators, to the network will produce another embodiment of the invention that supports bi-directional operation. Although a variety at technologies exist for amplifying optical signals, the erbium doped fibre amplifier is a commonly used component for this type of application. A person of skill in the art of optical network design will he aware that an EDFA with constant gain mode, fast transient response and a flattened gain response is particularly well suited to this application. This type of amplifier will ensure that all of the optical signals receive an equal amount of amplification when they are provided to the amplifier with substantially equal intensities, regardless of the number of optical signals provided to the amplifier. Thus, even when wavelength channels are being added and dropped, the amplification of an optical signal within a given wavelength channel remains substantially constant. Additionally, the impact of transient optical signals associated with switching optical signals will not interfere with the proper functioning of the network. The use of an EDFA with constant gain mode and fast transient response is also particularly well suited to the optical network of FIG. 2 when the switch fabric 22 supports fast switching. This will permit a network having a topology consistent with that of FIG. 2 to function as an optical burst network.

As demand for transferring in information changes within the network optical paths are rapidly changed. In a network according the invention it is a simple matter to ensure that the wavelength intensity profile of the optical signals provided to the amplifiers is properly suited to the amplifier. As one of skill in the art of optical network design will be aware, providing optical signals with an intensity profile properly matched to the optical amplifier is beneficial in avoiding saturation of the amplifier, thus controlling the level of noise of the optical signal. When the level of optical noise is maintained at a nominal value it allows the optical network to function with a low bit error rate. Additionally, ensuring that the noise is below a predetermined nominal level allows more optical amplifiers to be provided between the optical source and the receiver along a given optical path without compromising the bit error rate.

Adding extra sources, receivers and, subsystems to a network according to the invention will not disrupt the network provided that they also maintain the correct optical intensity throughout the shared network components. Once again, the optical signals are provided by the new sources at the correct intensities and therefore monitoring and intensity control during normal operation of the optical signals is unnecessary. Clearly changing optical components and optical fibre links will likely have an effect on the attenuation characteristic of an optical path and therefore, when the network of FIG. 2 is provided with a new the optical paths associated with new component are recalibrated. However, monitoring the optical signals in this type of optical network is useful for fault detection and preventative maintenance. Additionally, a person of skill in the art of optical networking will realize that a source module coupled to a switching node will function properly with the other network components when it provides optical signals to a predetermined intensity consistent with other optical signals provided to the switch. Thus, the embodiment shown in FIG. 2 illustrates a general case in which the sources and receivers are not optically proximate the switching fabric.

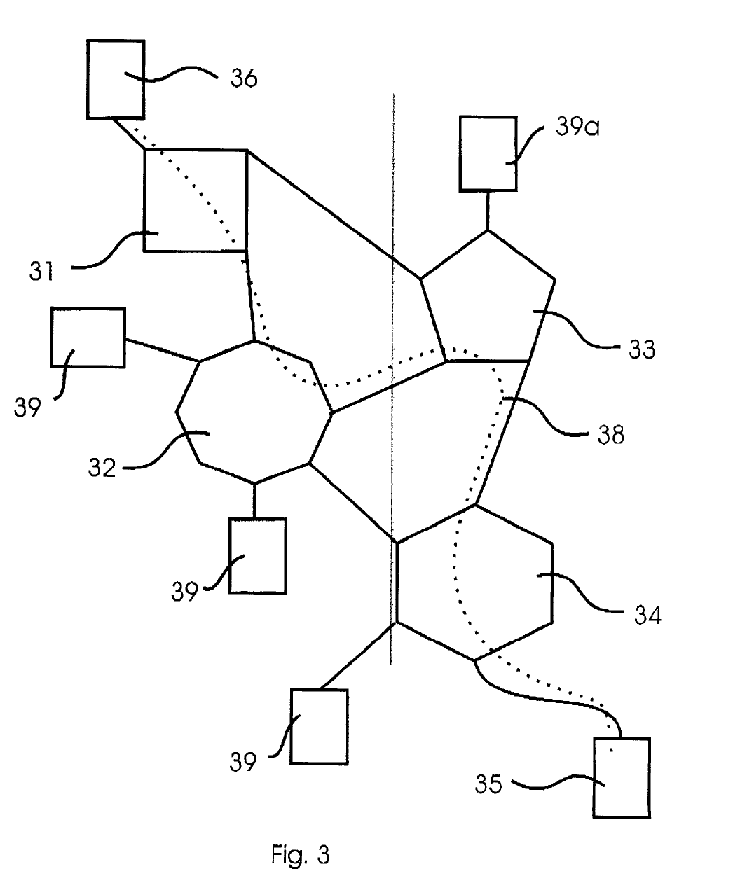

Referring to FIG. 3, a more complex embodiment of the invention is demonstrated in which a plurality of optical switch fabrics arc combined to form a mesh network. This embodiment includes four switch fabrics 31, 32, 33 and 34 respectively. The network has established an optical path 38 between the source 35 and the receiver 36. The path 38 represents only one of many possible routes between the source 35 and the receiver 36. The design of the network ensures that the intensity of the optical signal will be substantially equivalent when the optical signal propagates to the receiver 36 regardless of the optical path taken. Additionally, optical signals are amplified and attenuated at various points along the path to ensure that the intensities of the optical signals are consistent at predetermined locations. In this embodiment, an optical signal is provided to the optical network from the source 35. This optical signal propagates along the optical path 38. The optical signal has a predetermined intensity when it is received at an input port of the switch fabric 34. The optical signal is switched and propagates to switch fabric 33. Prior to being received by switch fabric 33, the optical signal is amplified by an optical amplifier optically disposed between switch fabrics 33 and 34. The amplifier increases the intensity of the optical signal to the same predetermined intensity. Other optical signals provided to the switch fabric 33 from the node, 39a are also provided at the same predetermined intensity. The switch fabric 33 receives and routes the optical signal. The optical signal continues propagating along the optical path 38 and is provided to another optical amplifier optically proximate switch fabric 32. The optical amplifier provides the optical signal with the same predetermined intensity. The switch fabric 32 routes the optical signal to switch fabric 31. Again, the optical signal is amplified prior to switch fabric 31 to ensure that the intensity of the optical signal is returned to that same predetermined intensity. Since optical signals are optionally created at any of the sources 39 in the network it is a simple matter to ensure that they all have substantially equal non-zero intensity when any of the switch fabrics 31, 32, 33 and 34 receives them. Similarly, it is a simple matter to add optical amplifiers or attenuators prior to the receiver to ensure that the optical intensity of the signal sent to the receiver is within a predetermined threshold consistent with that receiver. In this way, optical signals within the network will have a specific intensity that is consistent and predictable prior to being received by any component whose response to either the intensity profile or the intensity of an optical signal within a wavelength channel is critical. In a conventional optical network the various links between the different components would each have different loss characteristics. In this embodiment the loss of the optical paths is equalized for all of the optical paths between similar components to ensure that the optical intensity is predictable for all of the optical signals. The loss of the optical paths is controlled by the length and attenuation characteristics of the optical fibre in the link as well as attenuation provided by variable attenuators coupled with the link. Additionally, optical amplifiers are provided to increase the intensity of the optical signals. A person of skill in the art of optical components and networking will realize that optical components required for allowing bi-directional optical signal transmission on the network of FIG. 3 are not shown.

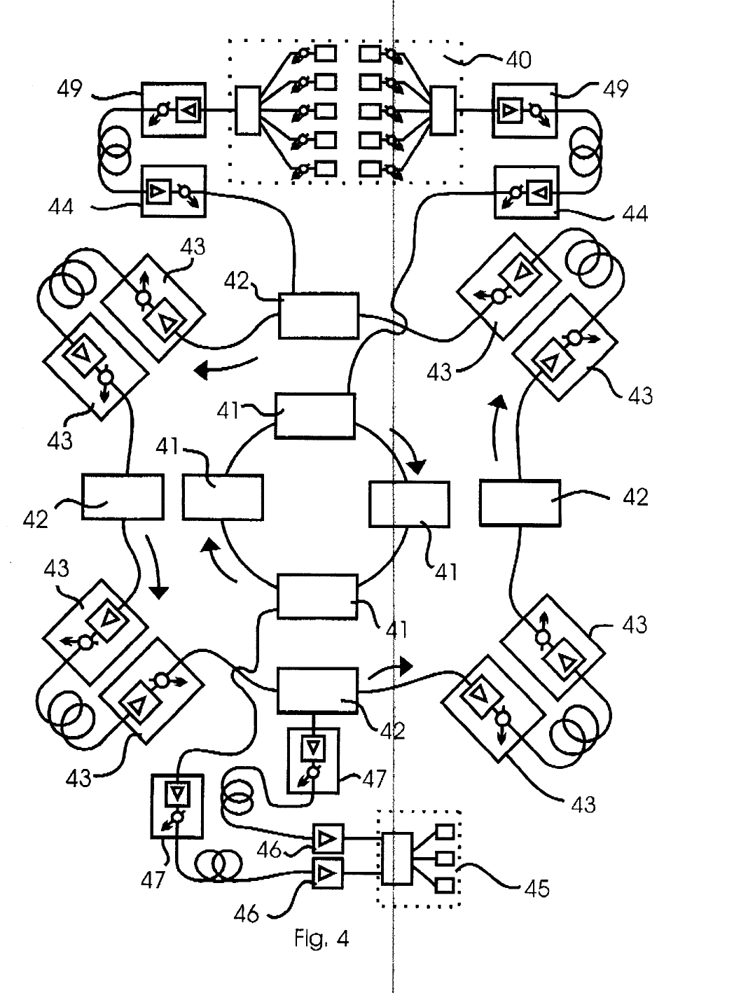

Referring to FIG. 4, a network according to the invention is shown featuring a ring architecture. Coupling the optical switches 41 of an inner ring forms a first ring. Coupling the optical switches 42 or an outer ring forms a second ring. The network includes laser sources. The source assembly 40 represents an assembly of lasers, each pair of lasers having two separate output ports. Each output port is coupled to a variable attenuator. The source assembly includes two wavelength division multiplexers for combining the optical signals. A first multiplexer is coupled to an optical amplifier module 41. The source assembly 40 provides two optical signals that are functionally equivalent. Although only one source assembly is shown, each of the switches 41 and 42 are optically coupled to a source assembly similar to the source assembly 40 with similar optical components disposed between the switches and source assemblies. A second similar optical signal is provided by the source assembly 40 for propagating along the inner ring of the optical network. This optical signal propagates along an optical path analogous to the optical signal that propagates along the outer path. The inner ring of the optical network allows optical signals to propagate in a clockwise direction while the outer ring allows optical signals to propagate in the counterclockwise direction, as shown. The optical switches 42 are optically coupled to amplifier modules 43. The amplifier modules 43 are shown in pairs with optical fibres coupling the pairs together. For simplicity, the amplifier modules and fibres of the inner ring are not shown. A receiver module 45 is shown optically coupled to receive signals from amplifiers 46. One of the amplifiers 46 is coupled to a switch module 42 from the inner ring while the other is coupled to a switch module 41 from the outer ring. Additional receivers and amplifiers (not shown) are coupled to a switch module from each of the inner ring and outer ring. In this way each of the switches in the inner ring is coupled to a source assembly and a receiver assembly. Additionally, each of the switches of the inner ring 41 has a corresponding switch in the outer ring 42.

In operation, an optical signal is provided from the source assembly 40. The variable optical attenuator 49 receives the optical signal and attenuates it to a correct intensity. The optical signal then propagates along a length of fibre and to an amplifier assembly 44. The optical amplifier 44 is optically proximate the switch 42 and therefore the amplifier assembly 44 provides the optical signal to the switch 42 at a predetermined optical intensity. The optical signal provided to the switch 42 propagates around the network in a counterclockwise direction. As it propagates within the network a first amplifier module 43 receives this optical signal. The amplifier assembly 43 provides gain to the optical signal to ensure that it is at a correct optical intensity when it is provided to a length of optical fibre. As the optical signal propagates within the optical fibre it loses intensity. Another amplifier module increases the intensity of the optical signal prior to providing it to the next optical switch 42 of the outer ring in this way, the intensity of the optical signal is substantially equivalent when the next optical amplifier receives it regardless of the optical path taken by the optical signal. Thus, in this network the optical intensity of the optical signals provided by any of the optical switches 41 and 42 is predetermined. Since the intensities are predetermined it is a simple matter to specify that the intensities of optical signals provided to each switch are to be equal. The optical signal continues propagating along the outer ring of the network until it is provided to a switch 72 that directs away from the outer ring. The optical signal propagates from the switch 42 to an amplifier module 47 where the optical intensity is adjusted to compensate for the attenuation of optical fibre optically disposed between the amplifier module 47 and the amplifier 46. The optical signal then propagates along that length of optical fibre. The optical fibre is coupled to an amplifier 46 that amplifies it once more. The optical signal is then provided to the receiver 45. As previously stated, this network is designed to provide another optical signal along a similar path along the inner ring of the network. This provides redundancy in the network that is advantageous because the network is able to continue functioning if the optical fibres between two adjacent nodes suffer a catastrophic failure. While this embodiment is shown with a dedicated inner ring and a dedicated outer ring a person of skill in the art will be aware that the addition of directional passive components will permit bi-directional operation for either ring.

Additionally, a person of skill in the art of optical networking will be aware that the switches used in the embodiment of FIG. 4 and the switches used in the embodiment of FIG. 3 are similar in that they both receive optical signals having specific predetermined intensities. Further a person of skill in the art will realize that the ring architecture of FIG. 4 is easily combined with the mesh architecture of FIG. 3 provided that the respective switches continue to receive optical signals at the same predetermined intensities. Clearly, the optical network described in FIG. 4 is directional whereas the embodiment described in FIG. 3 is intended to be bi-directional. Combining these specific embodiments typically requires direction specific optical components, such as circulators.

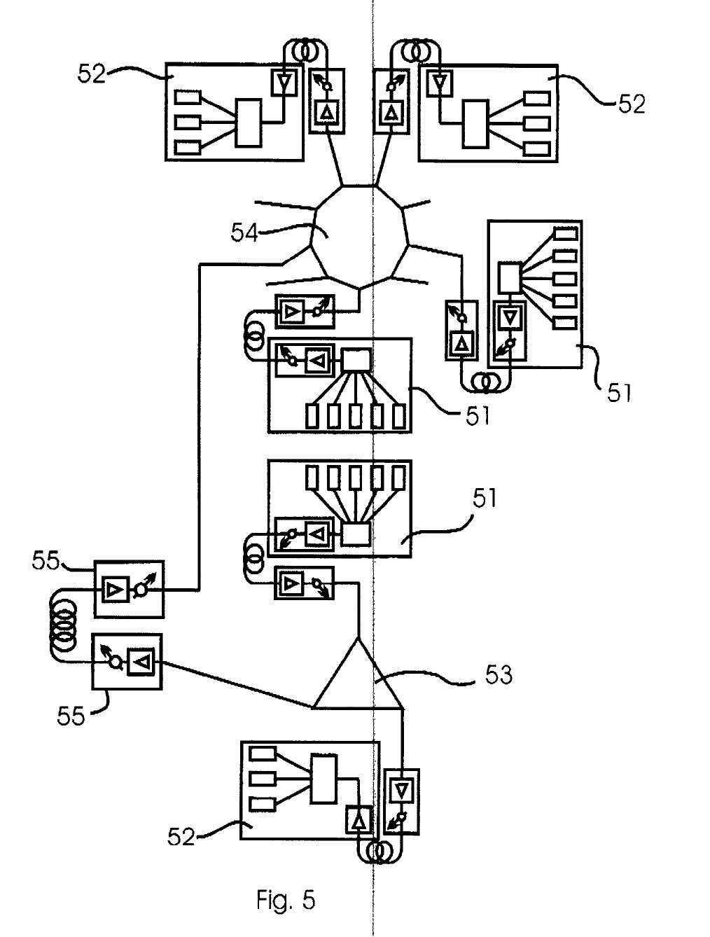

Referring to FIG. 5 another optical network according to the invention is shown. The network includes sources 51, receivers 52, a simple switch fabric 53, a complex switch fabric 54 and optical amplifier modules 55. The source 51 provides an optical signal to the simple switch fabric 53 at a first intensity. The signal propagates from the simple switch fabric 53 to the optical amplifier module 55 where the intensity of the optical signal is boosted to compensate for the attenuation of a length of fibre. The optical signal propagates along tile length of optical fibre and is provided to another optical amplifier module 55 where the intensity of the optical signal is amplified to a second intensity. The optical signal then propagates to a complex switch fabric 54 and then to a receiver 52. In this embodiment, the complex switch fabric 54 causes significantly more signal attenuation than the simple switch fabric 53. Consequently, the network is designed to receive optical signals at different intensities for the different switch fabrics. In this embodiment, every optical signal propagating to a given switch fabric has a specific optical intensity. Thus, the first intensity and second intensities are chosen to ensure that optical signals will have a substantially equal intensity when they propagate to any of the receivers 52, regardless of which switching fabric they propagated through last. This is advantageous because different switch fabrics are likely to have different attenuation characteristics due to their complexity and the technology they incorporate; however a given switch fabric has substantially equal loss characteristics for all of the selectable optical paths within the given switch fabric. Thus, the intensity of the optical signals is still predictable; however intensities vary with different components.

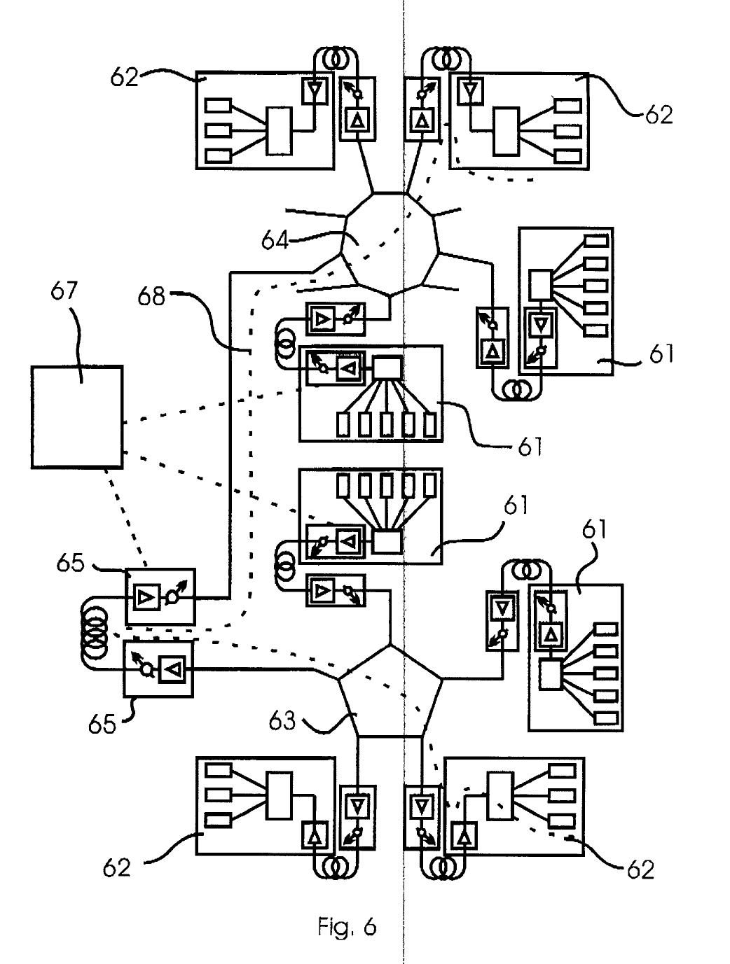

Referring to FIG. 6, a diagram of an embodiment of an inventive optical network topology is shown. This optical network features: laser sources modules 61, receiver modules 62, a first switch fabric 63, a second switch fabric 64, amplifier modules 65; and a network monitoring unit 67. In this embodiment, one of the laser source modules 61 produces an optical signal. The signal is amplified appropriately to ensure that it has a predetermined optical intensity when it reaches the first switch fabric 63. The optical signal is amplified by the amplifier module 65, routed through the second switch fabric 64 and propagates to one of the receiver modules 62. As the optical signal propagates front the laser source module 61 to the receiver module along optical path 68 the intensity of the optical signal is sensed by optical monitors present within the optical amplifiers disposed along the optical path at various locations of the network. These optical monitors provide data to a network monitoring unit 67. The network monitoring unit 67 uses this data to determine if any of the components of the network are failing. Since the optical intensity of an optical signal propagating within the network is predictable, deviations from the expected optical intensity of the signal indicate failing equipment, damaged optical fibres and optical components in need of service. For example, in the event that the optical intensity of an optical signal from a specific laser source shows a history of consistent, minute declines the network monitor unit 67 provides information to a technician indicating the potentially faulty component as well as the specifics of the problem. In this way, optical component failures are either avoided or rapidly addressed. Additionally, it is not necessary to replace laser sources until they are showing signs of failure, whereas in prior art networks, a prudent network administrator replaces all the lasers after a few have failed. In this way, the network shown in FIG. 6 is able to promptly indicate failing components as well as save money by avoiding catastrophic failures of the components or the premature replacement of components. FIG. 6 shows the network monitoring unit 67 coupled to only a few amplifiers to avoid unnecessary complexity in the drawing. Clearly, when the network monitoring unit is receiving data from more sources it will be able to provide better information. Optionally, the network monitoring unit 67 incorporates an expert system that performs diagnosis of problems. Additionally, when the expert system suspects that a component has failed in a given area of the network {useful expand on concept}, it causes the optical network to transmit diagnostic signals through suspect components thereby providing more data for the expert system. This additional data will improve the quality of the component failure predictions system of the expert system.

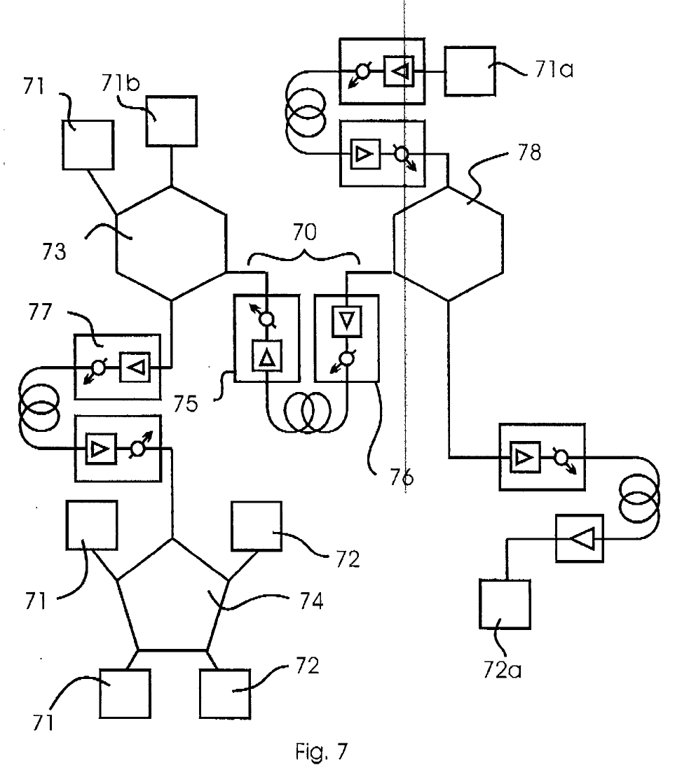

Referring to FIG. 7, an embodiment of the invention is provided. This optical network features; laser sources 71, receivers 72, a first switch fabric 73, a second switch fabric 74, amplifier assemblies 75 and 76 that act as bi-directional optical amplifiers with monitors and variable optical attenuators and an additional switch fabric 78 optically coupled to additional an laser source 71a and receiver 72a. The laser sources 71 and 71a include a set of lasers, each for radiating within specific wavelength channel, a variable optical attenuator optically coupled to each laser and a wavelength division multiplexer for combining the optical signals. The laser sources 71 provide optical data signals that propagate to the receivers 72. The switch fabrics selectably couple the sources 71 to the receivers 72. In this embodiment, the optical network is to be upgraded so that it is able to transfer data between witch fabric 73 and the additional switch fabric 78. The additional source 71a and the additional receiver 72a are already properly configured with the additional switch fabric 78 to provide and receive optical signals having the correct predetermined intensities. When the additional switch fabric 78 is initially coupled the first switch fabric 73 along a link 70 a test signal is provided from laser source 71a, it propagates to amplifier assembly 76 and is amplified. The attenuator in the amplifier assembly 76 is set to a minimum level of attenuation. The optical signal propagates to amplifier assembly 75 where it is monitored. The monitor provides intensity feedback data to amplifier assembly 76. The attenuator within amplifier assembly 76 is set such that the monitor of amplifier assembly 75 receives optical signals at a correct intensity. The attenuator of amplifier assembly 75 is set to a minimum level of attenuation and the optical signal propagates to the switch fabric 73 where it is routed to amplifier assembly 77. A monitor within amplifier assembly 77 provides intensity feedback data to amplifier assembly 75. The attenuator of the amplifier assembly 75 is set to provide an appropriate level of attenuation to ensure that the optical signal is provided to amplifier assembly 77 with a correct intensity. The amount of amplification and attenuation is verified when desired. However, in normal use, the system will work without recalibration. When equipment is changed in the link 70, the amplifier assemblies 75 and 76—or their equivalent replacement modules—are calibrated using the same method. A similar method is used to calibrate the amplifier assemblies 75 and 76 to support optical signals propagating from the switch fabric 73 to the additional switch fabric 78. Typically, the link 70 does not have significant wavelength dependencies. Consequently, the equalization of the link is provided with an optical signal at one wavelength and the equalization itself is carried over all of the supported wavelength channels. Clearly, in another embodiment in which the link 70 has wavelength dependencies and is used to support a plurality of wavelength channels then it is recommended that the various supported wavelength channels are equalized in such a way that the wavelength dependence of the link is mitigated. Incorporating a variable attenuator for each wavelength channel and calibrating each one independently accomplishes this. Optionally, the attenuation characteristic of the link 70 is adjusted periodically or in response to the detection of a fault in the network. Of course, a simpler embodiment that does not support different attenuation characteristics for each direction of optical propagation will function adequately with an amplifier/attenuator assembly that is not bi-directional. The embodiment uses laser sources with specific wavelengths and appropriate wavelength division multiplexer however, a person of skill in the art of optical components will realize that other combinations of optical components are easily combined to create a similar laser, source. For example, in another embodiment, the laser source is a modulated tunable laser with a variable optical attenuator.

While this embodiment describes a relatively simple optical network, a person skilled in the art of optical network design will realize that the number of nodes supported by the switching fabrics as well as the number of switching fabrics, sources and receivers are variable. Additionally, adding new components to the network is a simple matter from a power management point of view. Similarly, when existing equipment is upgraded, it is also configured and verified to have the correct optical loss characteristics. Clearly, a large number of amplifier modules are used to support a larger and more complex mesh style optical network. Fortunately, the various components used in the optical network according to the invention are standardized. In this way, their costs are reduced and maintenance of the system is simplified. Furthers removing a component from one location of the network and attaching it to another easily changes the network topology.

Referring again to FIG. 7, when a new laser source 71b is added to an existing network a similar process is followed. A test signal is provided from the laser source 71b. This signal is monitored in close optical proximity to a network element that receives optical signals at predetermined intensities. Once the test signal has been monitored, an attenuator disposed between the monitor and the source is adjusted to ensure that future optical signals from the same source will have the correct intensity when they are provided to the network. Once again, intensity levels are adjustable as required. In this way, components within the optical network adjusts all of the optical signal intensities automatically when new components are added or existing components are upgraded.

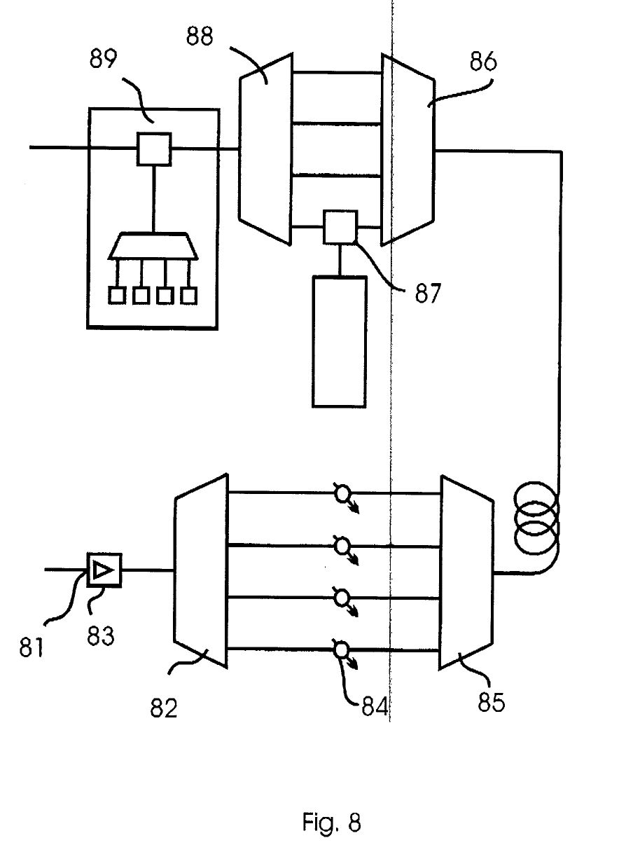

Referring to FIG. 8, an example of an optical path according to the invention is shown in which the optical path contains optical components that have different responses to optical signals within a given band. This embodiment includes: an amplifier 83 with an input port 81, a first wavelength demultiplexer 82, a set of attenuators 84, a first wavelength multiplexer 85, a second wavelength demultiplexer 86, a passive component 87, a second multiplexed 88 and a monitor 99. During configuration of the optical path a wavelength multiplexed optical signal with a desired wavelength profile and intensity is provided at the input port 81 of the optical amplifier 83. The optical signal is amplified and provided to the demultiplexer 82. The optical signal is demultiplexed in dependence upon wavelength. Each of the optical signals corresponding to supported predetermined wavelength channels is provided to an attenuator 84. The attenuator 84 is set to a minimum attenuation level. The optical signals are then provided to the first multiplexer 85. The first multiplexer 85 provides the wavelength multiplexed optical signal to a length of fibre. The optical signal propagates long the length of fibre and to the second demultiplexer 86. The optical signal is demultiplexed and one of the plurality of optical signals is partially attenuated by the passive component 87. Thus, when the optical signals are multiplexed by the second multiplexer, the wavelength profile is no longer flat. The monitor provides intensity feedback data to the attenuators 84. The attenuation is varied to provide an optical signal with the desired profile aid intensity optically proximate the monitor 89. When the appropriate values of attenuation are established the attenuators 84 are set to provide that level of attenuation continuously. The time required to configure the optical path is minimal since all of the operations are carried out automatically. When the path configuration is complete, the optical path is available for use by a network according to the invention. Clearly, numerous variations of this embodiment exist. For example, in another embodiment the amplifier 83 is replaced by a plurality of amplifiers, each amplifier optically disposed to precede an attenuator 84. Although FIG. 8 clearly shows equipment that supports four wavelength channels this need not be the case. The embodiment of FIG. 8 is easily modified to support a different number of wavelength channels. It is often the case that an optical path will have significant wavelength dependencies in that some optical signal corresponding to different wavelength channels are attenuated by different amounts. For example, although this embodiment features a component 87 that attenuates optical signals corresponding to a specific channel, in an alternative embodiment, the demultiplexers 82 and 86 have wavelength dependencies also. A person of skill in the are of optical networking will realize that this embodiment advantageously compensates for any of these dependencies.

Since the network does not rely on specialized optical equipment, an optical network according to the invention is easily produced from existing optical components. Thus, modifications to the network do not require proprietary equipment with regard to power management of the network and therefore the equipment selected for a network according to the invention is selected based on choosing the appropriate components and not based upon choosing proprietary equipment that may not be the best for the given application.

A network according to the invention makes use of attenuators that are remotely variable but otherwise function similarly to fixed attenuators. In this application, the attenuators do not need to react quickly since they are rarely adjusted. While it is advantageous in some circumstances to use a variable attenuator that separately attenuates the various wavelength channels this is not always necessary.

Intensity profile as used herein does not preclude the absense of an optical signal. An optical signal having 0 intensity is a special case wherein no data is being provided on the carrier and, as such, no carrier is present. Here, a non-propagating signal still falls within the intensity profile and merely has one of the intensity values unrepresented. If that carrier frequency were present, it too would fall within the intensity profile.

Numerous other embodiments may be envisaged without departing from the spirit or scope of the invention.

What is claimed is:

1. A network architecture for supporting switched burst optical data traffic comprising:
a plurality of optically coupled nodes comprising input ports and output ports, wherein, in use, at each optical output port of each node, a wavelength division multiplexed optical signal is provided having a predetermined relative intensity profile such that each optical input port coupled within the network and for receiving a wavelength division multiplexed signal from an output port is for receiving a wavelength division multiplexed signal with an approximately same relative intensity profile, wherein at least a node support switching of the wavelength division multiplexed signals and wherein at least some of the optically coupled nodes are absent circuitry for performing dynamic gain equalization, the predetermined relative intensity profile providing relative intensities between wavelength channels for which an optical data signal is present.

2. A network architecture according to claim 1 wherein the at least a node supporting switching is a node supporting channel selective switching for routing different optical signals within different wavelength channels from within different received multiplexed signals to a same multiplexed optical signal provided at a same output port thereof.

3. A network architecture according to claim 2 wherein the relative intensity profile provided at an output port is substantially maintained stable over time.

4. A network architecture according to claim 2 wherein the network comprises transmitters and receivers for supporting optical burst traffic.

5. A network architecture according to claim 3 wherein the at least one of the at least a node supporting switching is absent electronic circuitry for regeneration of optical signals propagating therein to support optical-electrical-optical dynamic gain equalization.

6. A network architecture according to claim 3 wherein the relative intensity profile provided at an output port is a relative intensity profile defining relative intensities for a predetermined number of wavelength channels and wherein a signal within said wavelength

7. A network architecture according to claim 5 wherein a wavelength division multiplexed signal absent of one or more signals still has the predetermined relative intensity profile.

8. A network architecture according to claim 1 wherein the relative intensity profile provided at at output port is a relative intensity profile defining relative intensities for a predetermined number of wavelength channels and wherein a signal within said wavelength channel appears with said relative intensity or is absent from the wavelength division multiplexed signal.

9. A network architecture according to claim 4 wherein a wavelength division multiplexed signal absent of one or more signals still has the predetermined relative intensity profile.

10. A network architecture according to claim 1 wherein the at least some of the optically coupled nodes are absent electronic circuitry for regeneration of optical signals propagating therein to support optical-electrical-optical dynamic gain equalization.

11. A network architecture according to claim 1 wherein at least one of the at least a node supporting switching performs only other than active manipulation of the relative intensity profile such that changes in the relative intensity profile of signals received result in changes in the relative intensity profile of signals provided.

12. A network architecture according to claim 1 wherein an output port is optically coupled to an input port of another node forming an optical path therebetween and wherein the attenuation within the optical path is compensated for by a fixed amplification set when the network is installed or during a calibration of the network such that signals do not require monitoring when received.

13. A network architecture according to claim 1 wherein the relative intensity profiles are determined before or during installation and wherein, in use, variation of the relative intensities of individual multiplexed signals within single wavelength channels is other than performed.

14. A network architecture according to claim 13 wherein the network is not self monitoring with respect to relative optical intensity.

15. A network node for supporting burst optical data traffic comprising:
a first node having a plurality of input ports and an output port, the first node for being provided a plurality of input wavelength division multiplexed signals each including channel signals within different wavelength channels having a same predetermined intensity profile, for switching of the channel signals and for providing a first output signal having channel signals from different optical signals of the plurality of input wavelength division multiplexed signals and having a first predetermined output intensity profile, the first node absent a dynamic gain equalizer for actively equalizing wavelength division multiplexed signals provided at the output port thereof or at tho input ports thereof.

16. A network node according to claim 16 wherein the relative intensity profile provided at the output port is a relative intensity profile defining relative intensities for a predetermined number of wavelength channels and wherein a signal within said wavelength channel appears with said relative intensity or is absent from the wavelength the division multiplexed signal.

17. A network node according to claim 16 wherein the same predetermined intensity profile does not vary in time.

18. A network node according to claim 17 wherein the intensity is maintained at a constant level for a plurality of different sequential data bursts.

19. A network node according to claim 17 wherein the intensity is maintained at a constant level until changes to the network infrastructure optically proximate the node are made.

20. A network node according to claim 17 wherein the network node is absent optical monitoring.

21. A network node according to claim 16 wherein the relative intensity profile provided at an input port is a relative intensity profile defining relative intensities for a predetermined number of wavelength channels and wherein a signal within said wavelength channel appears with said relative intensity or is absent from the wavelength division multiplexed signal.

22. A network node according to claim 21 wherein the same predetermined intensity profile does not vary in time.

23. A network node according to claim 22 wherein the network node is absent optical monitoring.

24. A network node according to claim 17 additionally comprising:
at least an optical monitor for monitoring the wavelength profile of optical signals optically proximate the node, each of the at least a monitor having an output port for providing wavelength profile data and,
a network monitoring unit for receiving wavelength profile data and maintaining a database of wavelength profile information.

25. A network node according to claim 24 wherein the network monitoring unit is for carrying out analysis of wavelength profile data in comparison to wavelength profile information stored in the database.

26. An optical component comprising:
a first input port for receiving a plurality of optical signals multiplexed within a same waveguide;
a second input port for receiving data, the data in indicative of signal intensities of signals within a multiplexed signal, the signal intensities detected at each of a plurality of input ports of another optical component; and,
an optical amplifier/attenuator for amplifying optical signals within the multiplexed optical signal independently, the amplification performed in dependence upon a signal received at the second input port, the amplification for equalizing signal intensities at the input port of the another optical component, and the amplification performed in an approximately fixed fashion wherein the amplification other than varies dynamically with signal intensity of the received data signals,
wherein the optical component is absent gain equalization means prior to the signal being provided to the optical amplifier.

27. An optical component according to claim 26 comprising a third input port for receiving a plurality of optical signals multiplexed within a same waveguide,
wherein the optical amplifier/attenuator is for amplifying optical signals within the multiplexed optical signal independently, the amplification performed in dependence upon a signal received at the second input port, the amplification for equalizing signal intensities at each of the input port and the third input port of the another optical component, and the amplification performed in an approximately fixed fashion wherein the amplification other than varies dynamically with signal intensity of the received data signals.

28. An optical component according to claim 26 wherein the relative intensity profile provided at the second input port is a relative intensity profile defining relative intensities for a predetermined number of wavelength channels and wherein a signal within said wavelength channel appears with said relative intensity or is absent from the wavelength division multiplexed signal.

29. An optical component according to claim 28 wherein the relative intensity profile provided at the second input port is a relative intensity profile defining relative intensities for a predetermined number of wavelength channels and wherein a signal within said wavelength channel appears with said relative intensity or is absent from the wavelength division multiplexed signal.

30. An optical component according to claim 28 wherein the relative intensity profile provided at the second input port does not vary with time.

31. An optical component according to claim 26 wherein the optical component is absent electronic circuitry for regeneration of optical signals propagating therein to support optical-electrical-optical dynamic gain equalization

32. A method of equalizing a multiplexed optical signal comprising the steps of:
providing a first optical component and a second other optical component separated by a distance and disposed at different network locations;
providing a wavelength multiplexed optical signal to a first input port of the first optical component;
monitoring the provided optical signal to determine an intensity profile thereof proximate the first input port;
providing a feedback signal indicative of the monitored intensity profile to the second other optical component;
receiving the feedback signal at the second other optical component;
within the second other optical component, setting an approximately fixed amplification for each of different optical signals within said wavelength multiplexed optical signal independently in dependence upon the received feedback signal; and,
providing the amplified multiplexed optical signal from the second other optical component to the first optical component, the fixed amplification for resulting in an approximately fixed relative intensity profile for each amplified multiplexed optical signal.

33. A method of equalizing a multiplexed optical signal according to claim 32 wherein the first optical component comprises two input ports each for receiving a multiplexed optical signal and wherein the provided feedback signal is dependent upon a multiplexed optical signal intensity profile and a predetermined optical intensity profile.

34. A method of equalizing a multiplexed optical signal according to claim 32 wherein the first optical component comprises two input ports each for receiving a multiplexed optical signal and wherein the provided feedback signal is dependent upon each of the two multiplexed optical signal intensity profiles.

35. A method of equalizing a multiplexed optical signal comprising the steps of:
providing a first wavelength multiplexed optical signal to a first input port of a first optical component;
providing a second wavelength multiplexed optical signal to a second input port of the first optical component;
monitoring the first optical signal to determine ay intensity profile thereof proximate the first input port;
monitoring the second optical signal to determine an intensity profile thereof proximate the second input port;
providing a first feedback signal indicative of the monitored intensity profile to a second other optical component;
providing a second feedback signal indicative of the monitored intensity profile to a third other optical component;
receiving the first feedback signal at the second other optical component;
receiving the second feedback signal at the third other optical component;
within the second other optical component amplifying optical signals within said wavelength multiplexed optical signal independently in dependence upon the received first feedback signal;
within the third other optical component, amplifying optical signals within said wavelength multiplexed optical signal independently in dependence upon the received second feedback signal;
providing the amplified multiplexed optical signal from the second other optical component to the first optical component; and
providing the amplified multiplexed optical signal from the third other optical component to the first optical component,
wherein the intensity profiles of the received multiplexed optical signals at the first optical component are within known tolerances of at least a predetermined intensity profile.

36. A method of equalizing a multiplexed optical signal according to claim 35 wherein the intensity profiles are approximately identical intensity profiles for signals within same wavelength channels when present.

37. A method of transmitting optical data comprising:
providing a test signal with a known intensity from a transmitter,
monitoring the intensity of the test signal proximate an amplifier/attenuator,
providing data from the monitor to the amplifier/attenuator,
setting the amplifier/attenuator to a predetermined approximately fixed gain response in dependence upon the data provided from the monitor,
providing a wavelength multiplexed data signal from the transmitter,
amplifying the wavelength multiplexed data signal according to the approximately fixed gain response of the amplifier/attenuator and absent dynamic gain equalization.
